(19) United States
(12) Patent Application Publication
(10) Pub. No.: US 2024/0420594 A1
(43) Pub. Date: Dec. 19, 2024

(54) NEONATAL CIRCUMCISION TRAINING MODEL

(71) Applicant: Virginia Commonwealth University, Richmond, VA (US)

(72) Inventors: Casey Freymiller, Richmond, VA (US); Philip Kum-Nji, Richmond, VA (US); David Cohen, Richmond, VA (US); Derek Avery, Stafford, VA (US); Helina Afework, Sterling, VA (US); Rand Gabriel M. Buenaventura, Arlington, VA (US); Anwulika Molokwu, New York, NY (US); Sarah Zaidan, Henrico, VA (US)

(21) Appl. No.: 18/743,780

(22) Filed: Jun. 14, 2024

Related U.S. Application Data
(60) Provisional application No. 63/472,851, filed on Jun. 14, 2023.

(51) Int. Cl. G09B 23/30

(52) U.S. Cl. CPC G09B 23/30

(57) ABSTRACT

A neonatal circumcision training model serves as a life-like penis model on which medical practitioners may train in circumcision procedures. An exemplary model includes simulants of glans and shaft of the penis covered by a fascia-analog layer and a skin-analog layer. The layers are distinct and separable from one another and facilitate training medical professionals to spot the facia layer and distinguish it from the skin layer.

### CROSS-REFERENCE TO RELATED APPLICATIONS

This application claims the benefit of U.S. Provisional Patent App. No. 63/472,851, filed Jun. 14, 2023, the complete contents of which are herein incorporated by reference.

### FIELD OF THE INVENTION

The invention generally relates to medical training models and, in particular, a life-like training model for neonatal circumcision simulation for use with any clamp method.

### BACKGROUND

A need for medical training materials for circumcision has existed for decades. This is evidenced by, for example, U.S. Pat. No. 7,080,984 B1 to Cohen, which dates to the early 2000s. Cohen describes a circumcision training device in which portions of the simulated disposable foreskin may be doubled back to establish inner and outer layers over the glans. Other attempts at training models have been made over the years, with many tailored exclusively to modeling adult patients. For instance, U.S. Pat. No. 8,641,423 B2 to Gumkowski describes a circumcision testing and training model for an adult penis. A tube of flexible material is provided to form an artificial foreskin over glans and base components. The tube has a bend so that one portion is bent back over another portion. U.S. Pat. No. 11,804,149 B2 to Trotta et al. describes molded adult male genitalia models, some of which have a retractable foreskin.

Despite the long recognized need for medical training materials for circumcision, the need has not been satisfactorily met. The foregoing devices, for instance, poorly simulate real anatomy, especially real foreskin anatomy. In addition, models tailored to adult male anatomy are unsuited for the training of neonatal circumcision.

### SUMMARY

According to some embodiments, an exemplary circumcision training model for neonatal circumcision simulation may include a glans simulant configured to correspond to a neonatal glans; a shaft simulant configured to correspond to a neonatal penile shaft; a fascia-analog layer situated over the glans simulant and shaft simulant; and a skin-analog layer situated over the fascia-analog layer, glans simulant, and shaft simulant. The skin-analog layer has a larger maximum outer diameter over the glans simulant than over the shaft simulant. The glans, shaft, skin, and fascia layers of the model are collectively shaped to model/resemble/imitate an uncircumcised neonatal penis. One advantage of exemplary models according to this disclosure is training medical professionals to spot the facia layer distinct from the skin layer.

In exemplary training models, the fascia-analog layer and the skin-analog layer are separate and separable structures. The layers have the capacity for appreciable relative movement and being pulled apart. The layers are elastically deformable. Suitable materials include various elastomers such as but not limited to latex rubber, silicone, and nitrile. Skin-analog and fascia-analog layers may be removed and replaced, meaning a particular glans/shaft simulant may be reused while the skin-analog and fascia-analog layers are discarded or recycled. Each of the skin-analog and fascia-analog layers may have thickness in the range of 0.010 to 0.10 inches.

Exemplary penis models according to this disclosure may be used in the training of generations of medical students, residents, traditional mohels, and faculty physicians from several specialties (family medicine, pediatrics, urology, obstetrics) in the techniques of circumcision. Exemplary models may be used for training medical professionals according to any known circumcision method, including techniques which employ the Mogen clamp (Mogen Instruments, Brooklyn, NY), the Gomco clamp (Allied Healthcare Products, St. Louis, MO), or the PlastiBell® device (Hollister Inc, Libertyville, IL).

Exemplary embodiments may entail attaching a training model to an anatomical doll prior to simulation. Attachment may be accomplished by, for example, a diaper with a hole in the center. Alternatively, more durable attachment methods may be used. The placement of an exemplary life-like training model on an anatomical doll offers a full patient real-life experience to learners and also saves the expense purchasing the entire doll, as the doll may be used for other simulation purposes besides circumcision training.

Exemplary models according to this disclosure are susceptible to relatively inexpensive manufacture and offer a more cost-effective approach than existing models. Exemplary models nevertheless provide a realistic size and texture.

### BRIEF DESCRIPTION OF THE DRAWINGS

FIG. 1 is an illustration of anatomy pertinent to circumcision.

FIG. 2 is an exemplary circumcision training model for neonatal circumcision simulation.

FIG. 3 is part of the exemplary circumcision training model.

FIG. 4 is a cross-sectional diagram of the exemplary circumcision training model.

FIG. 5 is an exemplary anatomically sized doll with attached circumcision training model.

FIG. 6 is an exemplary method of producing a neonatal circumcision training model.

### DETAILED DESCRIPTION

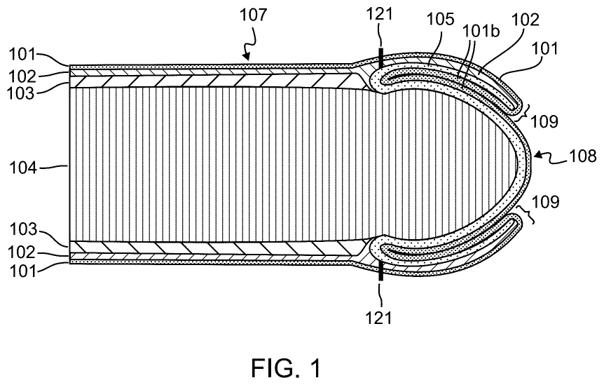

FIG. 1 is an illustration of anatomy pertinent to circumcision. In particular, FIG. 1 shows in cross-section different tissues of the distal part of the penis shaft 107 and of the glans 108. The cross-section is off-center and therefore does not include the urethra. The illustrated penis is uncircumcised with the result that foreskin 109 is present covering part of the glans 108. At a macro scale, the penis is typically characterized as having three main parts: a proximal root (not illustrated), shaft 107 (i.e., middle body or corpus), and glans 108 (i.e., head). The details of the uncircumcised penis depicted in FIG. 1 are part anatomical and part histological. At the cellular level, the foreskin 109 is generally recognized as including outer skin (epithelium) 101, dartos fascia 102, lamina propia 105, and inner mucusa (inner squamous epithelium) 101b. However, from the prospective of a medical doctor or other health professional performing a neonatal circumcision, two particular layers are especially recognizable during surgery and thus relevant to the procedure: (outer) skin 101 and dartos fascia 102. Briefly, circumcision conventionally entails the following steps. Adhesions connecting the foreskin 109 and glans penis 108 are taken down with hemostats. A slit is created on the dorsal aspect of the foreskin. The glans penis 108 is exposed and the remaining adhesions are taken down. The clamp (e.g., Mogen or Gomco) is applied and secured. The foreskin is excised with a scalpel and the clamp is removed. If bleeding is noted after excision, pressure with or without clotting gauze is applied to the site. A suture may be placed to control bleeding as well.

Irrespective of procedure (e.g., Mogen, Gomco, or PlastiBell®), the excision corresponds with a longitudinal position of the shaft 107 at the approximate level of the glans corona 110. FIG. 1 includes lines 121 which approximate general positions where a typical excision may be made. The medical professional must be attentive to cutting through both the skin layer 101 and the fascia layer 102 for the procedure to be a success.

The fascia layer 102 is, more specifically, dartos fascia. Beneath the dartos fascia is buck's fascia 103, which is not to be cut. The penis further includes such distinguishable tissues as the tunica albuginea, corpus cavernosum, and corpus spongiosum. These tissues are not of particular relevance to circumcision and are therefore not separately illustrated in the region 104 of FIG. 1.

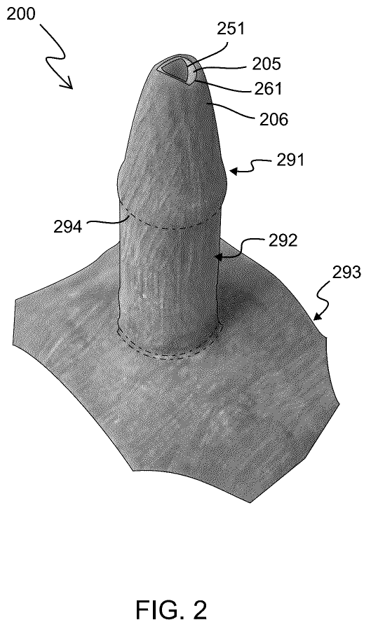

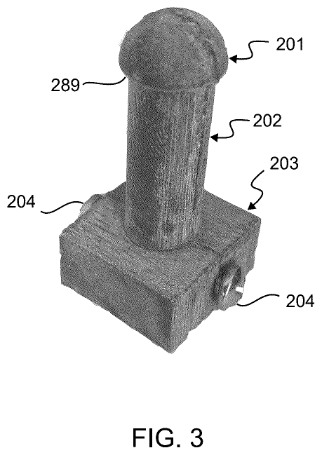

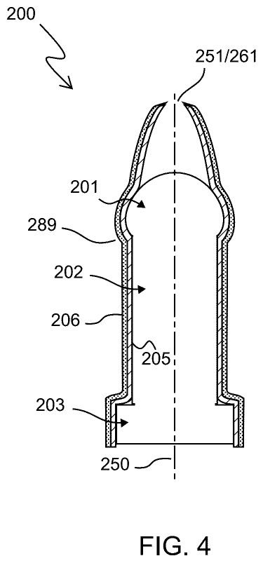

FIG. 2 is an exemplary circumcision training model 200 for neonatal circumcision simulation. The model 200 is modeled after a real neonatal penis and includes a shaft 292 and an uncircumcised head 291 exhibiting a corona 294. The model 200 also includes a base 293 which may or may not be included depending on the embodiment. The model 200 is particularly concerned with providing life-like simulation of the skin layer and (dartos) fascia layer typical of a real, human uncircumcised penis (e.g., see tissue layers 101/and 102 of FIG. 1). The following explanation of model 200 refers variously to FIG. 2 for a full assembly view, FIG. 3 for a view of interior elements of the assembly, and FIG. 4 for a cross-sectional view.

FIG. 3 shows interior elements of the model 200, namely a glans simulant 201 and a shaft simulant 202. As their names imply, glans simulant 201 is configured to correspond to a neonatal glans (e.g., in size and shape), and shaft simulant 202 is configured to correspond to a neonatal penile shaft (e.g., in size and shape). In the context of this disclosure, the terms “simulant,” “analog,” ‘model,” and “replica” may generally be used interchangeably. The glans simulant 201 includes a corona 289. The glans simulant 201, especially in the region of the corona 289, has a larger cross-sectional size (e.g., circumference, diameter, perimeter, etc.) than does the shaft simulant 202. When a shaft simulant 202 is said to correspond to a neonatal penile shaft in size and shape, this description does not preclude the configuration of the shaft simulant omitting the volume and material which would correspond with an outer skin layer and dartos fascia layer of the penile shaft. A complete model 200 may have dimensions of, for example, 0.6 to 1.8 inches length and 0.2 to 0.6 inches diameter. In general, it is also desirable for exemplary models that material properties such as firmness and flexibility are used which analogize to the real tissues of a neonatal penis. To this end, exemplary materials from which to make the glans simulant and shaft simulant include but are not limited to silicone rubber.

The glans simulant 201 and shaft simulant 202 may be formed integrally (of unitary construction), e.g., they may together constitute a single piece. The glans simulant 201 and shaft simulant 202 may not be separable from one another. For instance, parts 201 and 202 may be manufactured by a casting process which casts the parts 201 and 202 as a single cast structure.

As best seen from the cross-sectional view of FIG. 4, the model 200 further includes a fascia-analog layer 205 and a skin-analog layer 206. The fascia-analog layer 205 is situated over the glans simulant 201 and shaft simulant 202, whereas the skin-analog layer 206 is situated over the fascia-analog layer 205, glans simulant 201, and shaft simulant 202.

The fascia-analog layer 205 and the skin-analog layer 206 are separate structures from one another. In general, the fascia layer is not continuous with the skin layer, at least not along any part of the length corresponding with the glans simulant. During actual use of the model, it is desirable that the layers 205 and 206 are physically separable from one another, especially since this behavior mimics the relationship between the real tissue layers of skin 101 and dartos fascia 102 (see FIG. 1). As depicted in FIG. 4, it is desirable that the layers 205 and 206 are in contact with one another, especially where they are both present over the shaft simulant 202 and in the vicinity of the corona 294. In addition, it is desirable that the fascia-analog layer 205 is in contact with the shaft simulant 202. Put another way, the fascia-analog layer 205 is sandwiched between the shaft simulant 202 and skin-analog layer 206 so as to make contact with the structures to either side. FIG. 4 also shows how the fascia-analog layer 205 is sandwiched between the glans simulant 201 and skin-analog layer 206 for at least a bottom half and generally more than a bottom half of the glans simulant 201.

The fascia-analog layer 205 and the skin-analog layer 206 both cover at least part of the glans simulant 201 and extend over and past the corona 289 of the glans simulant 201. The fascia-analog layer 205 and the skin-analog layer 206 may both extend more than a quarter inch or half inch past the corona 289 of the glans simulant 201 down the shaft simulant 202. FIG. 4 shows both layers 205 and 206 extended down an entirety of the shaft simulant 202, consistent with the extent of the anatomical layers of skin 101 and dart's fascia 102 visible in FIG. 1.

Despite the close contact of the layered structures of the model 200 when the fully-assembled model is at rest and prior to use, the layers are made to be independently deformable. The skin-analog layer 206 is temporarily separable from the fascia-analog layer 205 by application of a first external force and restores contact with the fascia-analog layer 205 if the first external force is removed. The fascia-analog layer 205 is elastically deformable such that the fascia-analog layer 205 is temporarily separable from the underlying simulant (e.g., glans simulant 201) by application of a second external force and restores contact with the underlying simulant if the second external force is removed. Besides being deformable, exemplary layers 205 and 206 are also elastic. The “temporary” qualifier to the separating of model parts just discussed accounts for the fact that after external forces are removed, the materials inherently return to substantially their original shapes/configurations. Of course, during actual use of a model 200, some of the layers 205 and 206 will be altogether removed from the model by physical excision.

The layers 205 and 206 are configured both with respect to material and dimension so the forces required to separate the layers from adjacent structures substantially correspond with the forces which a doctor may require to manipulate real skin and fascia layers of a human penis during a typical circumcision procedure. One or both of fascia-analog layer 205 and the skin-analog layer 206 may be made of latex rubber, for example, and each layer may have a thickness in the fully assembled state of model 200 of 0.01 to 0.10 inches, or more specifically 0.010-0.020 inches for some embodiments. The thickness of layer 205 may differ from the thickness of layer 206 in some embodiments, each tailored to better represent the different natural tissue type which it represents. It should be appreciated that excessively thick layers on models would not only render the models dimensionally non-analogous to actual neonatal penile tissues, they would also risk making realistic layer deformations too difficult if not impossible within the range of forces medical professionals are expected to supply with only their hands and handheld medical instruments like hemostats which are used for manipulating the patient tissues during circumcision.

Native foreskin tissue has a yield strain of 0.35±0.02, ultimate tensile strength of 4.33±0.19 Mpa, elastic strain of 0.34±0.01, yield stress of 4.06±0.15 Mpa, and modulus of 11.78±0.68 Mpa (Rahmati, S., Jalili, A., Dehkordi, M. B., & Przedborski, M. (2022). An Effective Method for Decellularization of Human Foreskin: Implications for Skin Regeneration in Small Wounds. Cell journal, 24(9), 506-514.) Accordingly, in some embodiments, one or more of the skin-analog layer and the fascia-analog layer may be configured to have one or more of the following properties: yield strain of 0.20-0.50 (or 0.30-0.40), ultimate tensile strength of 3.0-6.0 (or 4.0-5.0) Mpa, elastic strain of 0.2-0.5 (or 0.3-0.4), yield stress of 2.5-5.5 (or 3.5-4.5) Mpa, and modulus of 10.5-12.5 Mpa. Exemplary materials for simulants and tissue analog layers in exemplary models may have hardness in the range of Shore A 0 to Shore A 30. In particular, Shore A 10-20 range is exemplary for simulating relatively resilient tissues like skin, whereas Shore A 15-30 is exemplary for simulating tissues such as some types of fascia. Each of the layers 205 and 206 may have differences from one another in material properties, such as flexibility and/or hardness. That is to say, layer 205 may be configured to have a different material hardness than layer 206 to help give a trainee an impression of different resistances to deformation from different tissue types during use of the model.

Consistent with actual neonatal anatomy, it is desirable for model 200 that the skin-analog layer 206 has a larger maximum outer dimension (e.g., diameter) over the glans simulant 201 than over the shaft simulant 202. Similarly, it is desirable for model 200 that the fascia-analog layer 205 has a larger maximum outer dimension (e.g., diameter) over the glans simulant 201 than over the shaft simulant 202. Both the skin-analog layer 206 and fascia-analog layer 205 may be generally characterized as being tubes or sleeves which envelop/surround (at least in radial directions) the glans simulant 201 and shaft simulant 206. The longitudinal axis 250 of the model 200 is depicted in FIG. 4, and the variable diameter of the layers 205 and 206 depending on longitudinal position along the axis 250 is apparent (see also variable diameter of skin-analog layer 206 in FIG. 2's perspective view of the full model assembly).

As seen in FIGS. 2 and 4, the fascia-analog layer 205 includes an opening 251, and the skin-analog layer comprises an opening 261. The openings 251 and 261 are both at a distal end of the model 200 (namely the distal end which corresponds with the glans simulant). In FIGS. 2 and 4 there is a distance (a separation) between the openings 251/261 and the distal end of the glans simulant 201. This distance may vary among alternative embodiments, and in some embodiments the distance may be non-existent. Actual penises vary in whether and to what extent the neonatal foreskin extends past the end of the glans. For instance, FIG. 1 gives a visual of a scenario in which the glans 108 is not fully covered at its distal end by the foreskin 109.

As visible in FIGS. 3 and 4, the model 200 may further include a platform 203 attached to or integrally formed with the shaft simulant 202. Punctures may be placed into bottom flanges of fascia-analog and skin-analog layers, and fasteners placed through the punctures and secured into platform 203 on non-adjacent (e.g., opposite) sides. Accordingly, layer 205 and/or layer 206 may be secured to the pedestal by more than friction if desired. The platform 203 may be configured to facilitate functions such as attachment to an anatomical doll that represents a remainder of an infant (e.g., including legs, torso, arms, head) and/or securing additional layers of material such as by fasteners 204 (e.g., screws).

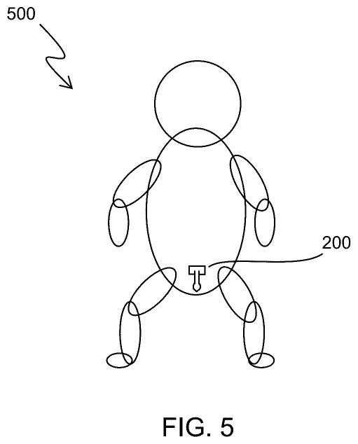

FIG. 5 is a basic illustration of a circumcision training model 200 attached to an anatomically sized doll 500. Exemplary circumcision training models may be used independently of or in connection with training dolls 500. The base 293 of FIG. 2 which comprises or consists of skin-analog layer 206 may be included for the model 200 when the model is intended for use in combination with a doll 500 and a desire exists for the base of a real neonatal penis to be more accurately portrayed. The base 293 may be configured to provide a more aesthetically seamless joinder with the materials forming the groin and lower abdomen of the doll. Alternatively, some embodiments of model 200 may forgo the base 293, a scenario illustrated by FIG. 4. With or without the base 293 which extends at least the skin-analog layer 206 radially out from the longitudinal axis of the model 200, the model 200 may nevertheless include the platform 203 which may be configured to structurally attach to a doll 500 and/or to assist in securing the layers 205 and/or 206 near the bottom end of the shaft simulant 202.

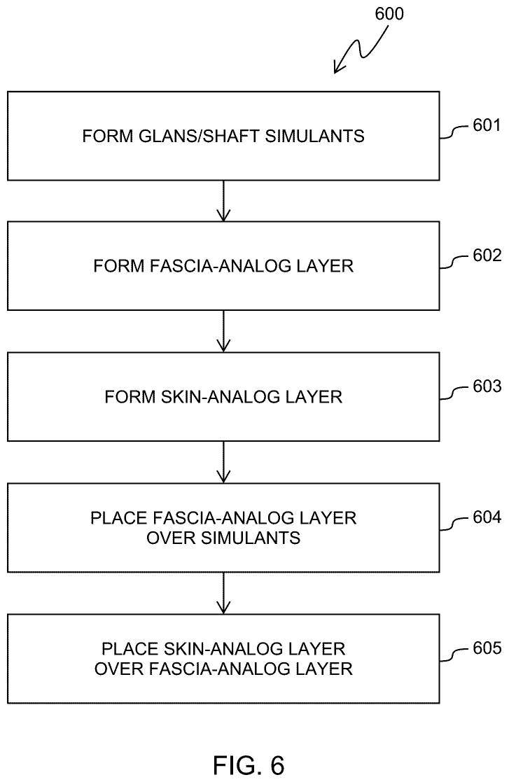

FIG. 6 is a flowchart of an exemplary method of producing a circumcision training model such as but not limited to model 200 illustrated by FIG. 2. Block 601 is forming simulants configured to correspond to a neonatal glans and a neonatal penile shaft. Block 602 is forming a fascia-analog layer. Block 603 is forming a skin-analog layer which is a separate structure from the fascia-analog layer. Block 604 is placing the fascia-analog layer over the simulants. Block 605 is placing the skin-analog layer over the fascia-analog layer. Generally speaking, the end product is consistent with the above disclosure characterizing exemplary model 200. For example, it is desirable that the simulants and analog are configured at their respective stages of production so that, once the respective elements are fully assembled with one another, the skin-analog layer has a larger maximum outer diameter over the glans simulant than over the shaft simulant.

Casting and injection molding are non-limiting examples of processes suited to the production of the glans/shaft simulants (block 601). Precursor materials may be mixed, poured into a mold, cured, then removed from the mold. An exemplary mold may be made by, e.g., 3D printing of an electronically generated neonatal glans penis and pedestal. However, because thin structures are difficult to cast, especially with consistent thickness, the steps of forming the fascia-analog layer and the skin-analog layer (blocks 602 and 603) may be deliberately made by non-casting processes such as but not limited to by painting or dipping. Furthermore, while parts may be made consecutively, various parts may also or instead by formed concurrently. That is to say, the flowchart of FIG. 6 is not intended to say steps 601, 602, and 603 need to be performed in the order depicted. Such steps may be performed in any order or at the same time as one another, for example.

Precursors used for the forming steps 601, 602, and 603 may be or include liquid or semi-liquid precursors. The forming steps may respectively include drying and/or curing (e.g., by UV, heat, cross-linkers, etc. or some combination of such options) such that the end result of the respective steps (which may themselves be subprocesses involving multiple substeps) are solid components. That is to say, the forming steps produce a solid (as opposed to liquid, gel, or gas) glans/shaft simulants, a solid fascia-analog layer, and a solid skin-analog layer. Exemplary solids are dried and/or cured silicone and/or latex rubbers, as mentioned above. Some embodiments may employ other materials of suitable material properties such as but not limited to nitrile.

Exemplary models may be configured to have colors and textures which imitate natural skin tones and textures of infants and to particular clinical populations. Dyes (e.g., latex dyes) may be mixed in to precursor mixtures prior to curing to supply red tones, brown tones, etc. Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described.

As used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only”, and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of events recited or in any other order which is logically possible.

While exemplary embodiments of the present invention have been disclosed herein, one skilled in the art will recognize that various changes and modifications may be made without departing from the scope of the invention as defined by the following claims.

What is claimed is:

1. A circumcision training model for neonatal circumcision simulation, comprising
a glans simulant configured to correspond to a neonatal glans;
a shaft simulant configured to correspond to a neonatal penile shaft;
a fascia-analog layer situated over the glans simulant; and
a skin-analog layer situated over the fascia-analog layer, glans simulant, and shaft simulant;
wherein the fascia-analog layer and the skin-analog layer are separate structures,
wherein the skin-analog layer has a larger maximum outer diameter over the glans simulant than over the shaft simulant.

2. The circumcision training model of claim 1, wherein the fascia-analog layer and the skin-analog layer both extend over and past a corona of the glans simulant.

3. The circumcision training model of claim 1, wherein the fascia-analog layer and the skin-analog layer both extend more than a quarter inch past a corona of the glans simulant down the shaft simulant.

4. The circumcision training model of claim 1, wherein each of the fascia-analog layer and the skin-analog layer is 0.010-0.020 inches in thickness.

5. The circumcision training model of claim 1, wherein the fascia-analog layer comprises a first opening, the skin-analog layer comprises a second opening, and the first and second openings are at a distal end of the circumcision training model.

6. The circumcision training model of claim 1, wherein the fascia-analog layer and the skin-analog layer are made of latex rubber.

7. The circumcision training model of claim 1, wherein the glans simulant and shaft simulant are made of silicone rubber.

8. The circumcision training model of claim 1, wherein
the skin-analog layer is temporarily separable from the fascia-analog layer by application of a first external force and restores contact with the fascia-analog layer if the first external force is removed, and
the fascia-analog layer is elastically deformable such that the fascia-analog layer is temporarily separable from the glans simulant by application of a second external force and restores contact with the glans simulant if the second external force is removed.

9. The circumcision training model of claim 1, wherein the glans simulant and shaft simulant are of a unitary construction.

10. The circumcision training model of claim 1, wherein the fascia-analog layer and the skin-analog layer are different thicknesses from one another.

11. The circumcision training model of claim 1, configured attached or attachable to an anatomical doll.

12. A method of making a circumcision training model for neonatal circumcision simulation, comprising
forming simulants configured to correspond to a neonatal glans and a neonatal penile shaft;
forming a fascia-analog layer;
forming a skin-analog layer which is a separate structure from the fascia-analog layer;
placing the fascia-analog layer over the simulants; and
placing the skin-analog layer over the fascia-analog layer,
wherein the skin-analog layer has a larger maximum outer diameter over the glans simulant than over the shaft simulant.

13. The method of claim 12, wherein the steps of forming the fascia-analog layer and the skin-analog layer are non-casting processes.

14. The method of claim 12, wherein the steps of forming the fascia-analog layer and the skin-analog layer are by painting or dipping.
